(19) United States
(12) Patent Application Publication
(10) Pub. No.: US 2026/0240700 A1
(43) Pub. Date: Aug. 20, 2026

(54) SEATED POSITIONING SYSTEM

(71) Applicant: Sage Products, LLC, Cary, IL (US)

(72) Inventors: Kunal Gupta, Agra (IN); Mary Kritikos, Elmhurst, IL (US); Alex Chelminski, Cary, IL (US)

(73) Assignee: Sage Products, LLC, Cary, IL (US)

(21) Appl. No.: 19/543,766

(22) Filed: Feb. 18, 2026

Related U.S. Application Data
(60) Provisional application No. 63/760,200, filed on Feb. 19, 2025.

(51) Int. Cl. A61G 5/10; A47C 7/14; A61G 5/14

(52) U.S. Cl. CPC A61G 5/1091; A47C 7/142; A61G 5/1056; A61G 5/14; A61G 2200/52

(57) ABSTRACT

A positioning system includes a base sheet and an inflatable cushion assembly. The inflatable cushion assembly is coupled to the base sheet. The cushion includes a top sheet, a bottom sheet, a first one-way valve, and a second one-way valve. The bottom sheet is coupled to the top sheet on a periphery of the bottom sheet. The bottom sheet cooperates with the top sheet to form the inflatable inner cushion, the inflatable outer cushion, and the formed region. The inflatable outer cushion is positioned adjacent to the inflatable inner cushion such that the inflatable outer cushion is positioned between the periphery and the inflatable inner cushion. The formed region extends a first distance from a first edge of the bottom sheet to define the inflatable inner cushion and the inflatable outer cushion. The first one-way valve is coupled to the first edge of the bottom sheet.

### CROSS-REFERENCE TO RELATED PATENT APPLICATION

The application claims priority to and the benefit of U.S. Provisional Patent Application No. 63/760,200, filed Feb. 19, 2025, the disclosure of which is incorporated herein by reference in its entireties for all purposes.

### TECHNICAL FIELD

The present disclosure relates generally to seated positioning systems. More specifically, this application relates to systems for facilitating positioning of a patient on a chair.

### BACKGROUND

Patients in medical facilities often suffer from various ailments or physical limitations. Such ailments or limitations commonly restrict the mobility of patients during treatment and observation. Some patients in medical facilities are not sufficiently mobile to self-transfer between a hospital mattress and other support surfaces within their designated room. These support surfaces may include hospital chairs, for example. As a result, these patients may become subject to fall risk when placed upon a hospital mattress or other support surfaces without sufficient staff observation. Other patients may suffer from immobility and become subject to pressure injuries (e.g., pressure ulcers, bedsores) when placed on a support surface. Pressure injuries may form due to prolonged pressure on bony areas of the body (e.g., lower back, tailbone, hips, buttocks, sacrum). A patient may also be injured by shear stress and friction on the patient's skin as the patient is dragged across or slips on a support surface. In each case, nurses and other caregivers at the medical facilities may often encounter difficulties in positioning patients in seated positions and/or maintaining the patients in seated positions.

### SUMMARY

One aspect of the present disclosure relates to a positioning system. The positioning system includes a base sheet and an inflatable cushion assembly. The inflatable cushion assembly is coupled to the base sheet. The cushion includes a top sheet, a bottom sheet, a first one-way valve, and a second one-way valve. The bottom sheet is coupled to the top sheet on a periphery of the bottom sheet. The bottom sheet cooperates with the top sheet to form the inflatable inner cushion, the inflatable outer cushion, and the formed region. The inflatable outer cushion is positioned adjacent to the inflatable inner cushion such that the inflatable outer cushion is positioned between the periphery and the inflatable inner cushion. The formed region extends a first distance from a first edge of the bottom sheet to define the inflatable inner cushion and the inflatable outer cushion. The first one-way valve is coupled to the first edge of the bottom sheet. The first one-way valve is in fluid communication with the inflatable inner cushion and facilitates flow of fluid into the inflatable inner cushion. The second one-way valve is coupled to the first edge of the bottom sheet. The second one-way valve is in fluid communication with the inflatable outer cushion and facilitates flow of fluid into the inflatable outer cushion.

Another aspect of the present disclosure relates to a positioning system. The positioning system includes a base sheet and an inflatable cushion assembly. The inflatable cushion assembly is coupled to the base sheet. The inflatable cushion assembly includes a top sheet, a bottom sheet, a formed region, a reservoir, an activator, and a protrusion. The top sheet and the bottom sheet include a first interior surface and a second interior surface coated with a first reactant. The bottom sheet is coupled to the top sheet on a periphery of the bottom sheet with the first interior surface and the second interior surface positioned towards one another to form the inflatable cushion assembly. The formed region extends a first distance from a first edge of the bottom sheet to define an inflatable inner cushion and an inflatable outer cushion. The reservoir is positioned at a first interior edge of the inflatable outer cushion and encloses a second reactant. The activator is positioned over the reservoir. The protrusion pierces the reservoir when a first force is applied to the activator, and the second reactant releases. The second reactant contacts the first reactant to facilitate a reaction producing a first gaseous product which fills the inflatable outer cushion.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a block diagram of an example seated positioning system;

FIG. 2 is a perspective view of an example positioning system mounted on a chair;

FIG. 3 is a block diagram of a portion of the positioning system of FIG. 2 placed on a portion of the chair;

FIG. 4 is a top cross-sectional view of an example inflatable cushion assembly;

FIG. 5 is a side view of the inflatable cushion assembly of FIG. 4 being inflated via an air cannister;

FIG. 6 is a top view of the air cannister of FIG. 5;

FIG. 7 is a top view of the inflatable cushion assembly of FIG. 4 being inflated via a first chemical reaction within the inflatable cushion assembly;

FIG. 8 is a top view of the inflatable cushion assembly of FIG. 4 being inflated via a chemical reaction within a reservoir;

FIG. 9 is a top view of the inflatable cushion assembly of FIG. 4 being inflated via a chemical reaction initiated by an electrical signal;

FIG. 10 is a side view of another example inflatable cushion assembly;

FIG. 11 is a block diagram of another example positioning system;

FIG. 12 is a perspective view of an arm hook assembly of a seated positioning system mounted on a chair;

FIG. 13 is a perspective view of a hook of the arm hook assembly of FIG. 12 mounted on a chair;

FIG. 14 is a perspective view of a bracket of the arm hook assembly of FIG. 12;

FIG. 15 is a perspective view of the arm hook assembly of FIG. 12 interfacing with an inflatable cushion assembly of the seated positioning system;

FIG. 16 is a perspective view of a wedge assembly of the seated positioning system mounted on a chair;

FIG. 17 is another perspective view of a wedge assembly of a seated positioning system mounted on a chair;

FIG. 18 is a perspective view of a wedge assembly of a seated positioning system interfacing a positioning system of the seated positioning system of mounted on a chair;

FIG. 19 is a block diagram of a patient monitoring system;

FIG. 20 is a top view of the patient monitoring system of FIG. 19; and

FIG. 21 is a block diagram of the user interface of a patient monitoring system of FIG. 19.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Implementations described herein relate to a seated positioning system. The seated positioning system may be utilized in a hospital, clinic, assisted living, or other similar patient care setting. The seated positioning system includes a positioning system and a chair. The positioning system is configured to support a patient on the chair. The positioning system mitigates risk of a patient falling when the patient is using the chair. For example, the positioning system may be used by a nurse to assist a patient in standing up from the chair. The seated positioning system may be particularly beneficial for patients with decreased mobility where a risk of fall is relatively high.

Additionally, the positioning system may mitigate occurrence of pressure injuries (e.g., pressure ulcers, bedsores) due to the patient sitting in the chair. The positioning system mitigates frequency in which a nurse must position a patient when seated in the chair. For example, the positioning system may be used to support a patient seated on the chair for a prolonged period of time. The seated positioning system may be particularly beneficial for patients with severely decreased mobility.

Additionally, the positioning system may decrease strain on a nurse when positioning a patient. For example, the positioning system may assist a nurse in pushing or pulling a patient backward in a hospital chair to be seated in the proper position. As another example, the positioning system may prevent a patient from sliding downward and forward in a chair after proper positioning, decreasing the frequency the position of a patient must be adjusted. The seated positioning system may be particularly beneficial for nurses providing care to patients with decreased mobility.

The positioning system may also be configured to be compressed prior to use with the chair. As a result, packaging of the positioning system may be more desirable because the positioning system requires less medical facility storage space. For example, the positioning system may be inflatable or constructed from compressible foam.

### II. Overview of Example Seated Positioning System

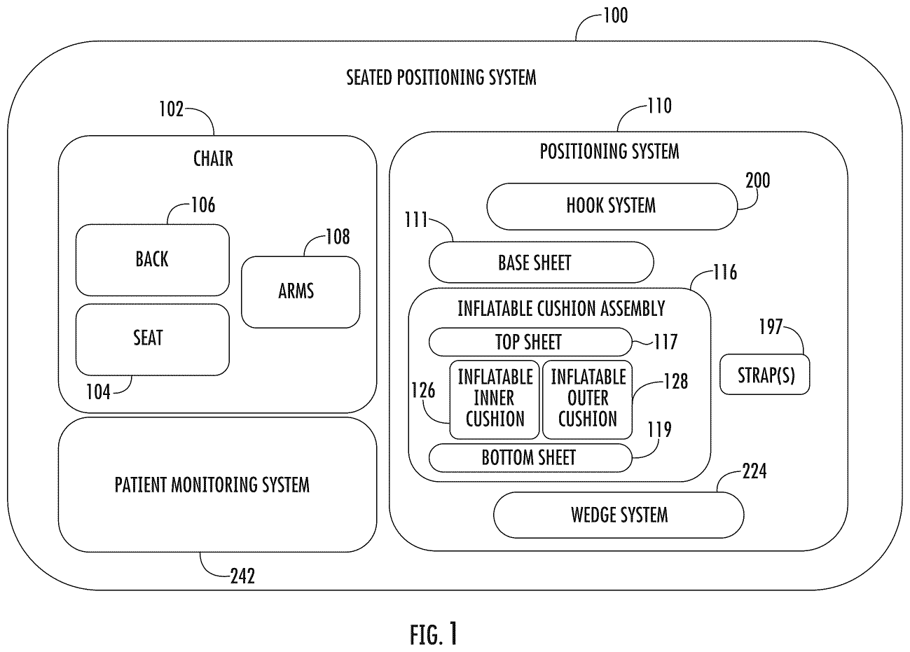

FIG. 1 illustrates a seated positioning system 100 (e.g., system). As is explained in more detail below, the seated positioning system 100 may be utilized by a nurse (e.g., caretaker, assistant) to provide care for a patient (e.g., human, elderly person, person with a disability), such as a patient with limited mobility.

The seated positioning system 100 includes a chair 102 (e.g., hospital chair, geriatric chair, bariatric chair, transport chair, wheelchair, seat for motorized vehicle, couch, bench). In some embodiments, the seated positioning system 100 includes a hospital bed instead of the chair 102 (e.g., to facilitate care of the patient in the hospital bed). The chair 102 includes a seat 104 (e.g., cushion, bottom). The seat 104 is configured to support lower extremities (e.g., upper thighs, buttocks) of a patient and a sacrum of the patient. The seat 104 may be constructed of a compressible material (e.g., foam, gel, fiber). The chair 102 also includes a back 106. The back 106 is configured to support a torso of the patient. The back 106 may also support a head of the patient. The back 106 is positioned at or along a rear end of the seat 104. In some embodiments, at least one of the seat 104 or the back 106 is adjustable. The chair 102 also includes arms 108. The arms 108 are configured to receive upper extremities (e.g., forearms, hands, shoulders) of the patient. The arms 108 may extend from the back 106. For example, the arms 108 may extend from the back 106 above and alongside the seat 104. Additionally, the arms 108 may extend from the seat 104 above and alongside the seat 104.

The seated positioning system 100 also includes a positioning system 110 (e.g., movement system, transfer system, cover system). The positioning system 110 is configured to be placed over the seat 104. In some embodiments, the positioning system 110 is configured to be placed on the back 106. As is described in more detail herein, the positioning system 110 eases (e.g., enhances, increases, improves) positioning of the patient on the chair 102. For example, the positioning system 110 may be used by a nurse to assist a patient in standing up from the chair 102.

The positioning system 110 includes a base sheet 111 (e.g., a transfer sheet). The base sheet 111 extends to cover at least a portion (e.g., front portion, top surface) of the seat 104. For example, the base sheet 111 may cover at least a portion of a top surface of the seat 104. In some applications, the base sheet 111 extends to cover a portion of the seat 104 as well as a portion of the back 106. For example, the base sheet 111 may cover at least a portion of a top surface of the seat 104 and at least a portion of a top surface of the back 106. The base sheet 111 assists the nurse in manipulating a patient relative to the seat 104. For example, a sacrum and lower extremities of the patient may be placed on the base sheet 111, and a nurse may pull the base sheet 111 towards the back 106 to position the patient relative to the chair 102. In some embodiments, incontinence pads, blankets, additional cushions, or similar devices may be placed on the transfer sheet before the sacrum and/or lower extremities of the patient are placed on the base sheet 111.

The base sheet 111 includes a material that has a first coefficient of friction. As is described in more detail herein, the material of the base sheet 111 is configured such that the first coefficient of friction facilitates retention of the base sheet 111 on the seat 104 and/or the back 106. The base sheet 111 may include nylon, polyester, high-density polyethylene (HDPE), polypropylene, cotton, or other similar materials.

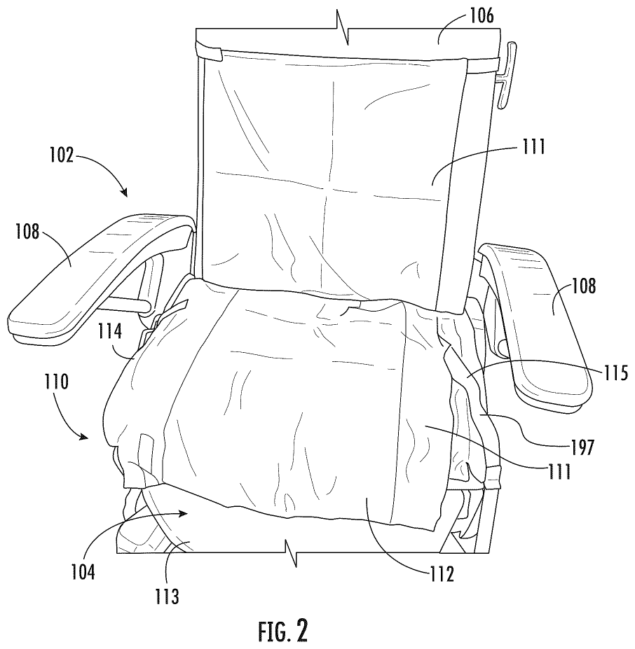

As shown in FIG. 2, the positioning system 110 includes a retention layer 112 (e.g., retention strip, retention material, etc.). The retention layer 112 is coupled to the base sheet 111. In various embodiments, the retention layer 112 is coupled to the base sheet 111 such that when a portion of the patient is placed on the base sheet 111, the portion of the patient is placed on the retention layer 112.

The retention layer 112 is made from a different material than the base sheet 111. The retention layer 112 is configured to restrict (e.g., resist, impede, slow) frontward movement of a patient placed on the retention layer 112 (e.g., movement of the patient placed on the retention layer 112 in a first direction, movement of a patient placed on the retention layer 112 towards a front edge 113 of the seat 104) while facilitating unrestricted movement of the positioning system 110 relative to the chair 102. The retention layer 112 is configured to restrict (e.g., resist, impede, slow) leftward or rightward movement of a patient placed on the retention layer 112 (e.g., movement of the patient placed on the retention layer 112 in a second direction towards a side edge of the base sheet 111 or third direction towards an opposite side edge of the base sheet 111, movement of a patient placed on the retention layer 112 towards a left edge 114 or a right edge 115 of the seat 104) while facilitating unrestricted movement of the positioning system 110 in a direction parallel to a side edge of the base sheet 111 and/or the left edge 114 and/or the right edge 115.

The retention layer 112 includes a material that has a second coefficient of friction. The material with the second coefficient of friction is configured to restrict movement while the material. The second coefficient of friction is greater than the first coefficient of friction of the base sheet 111. As a result, movement of a portion of a patient along the base sheet 111 is easier than along the retention layer 112.

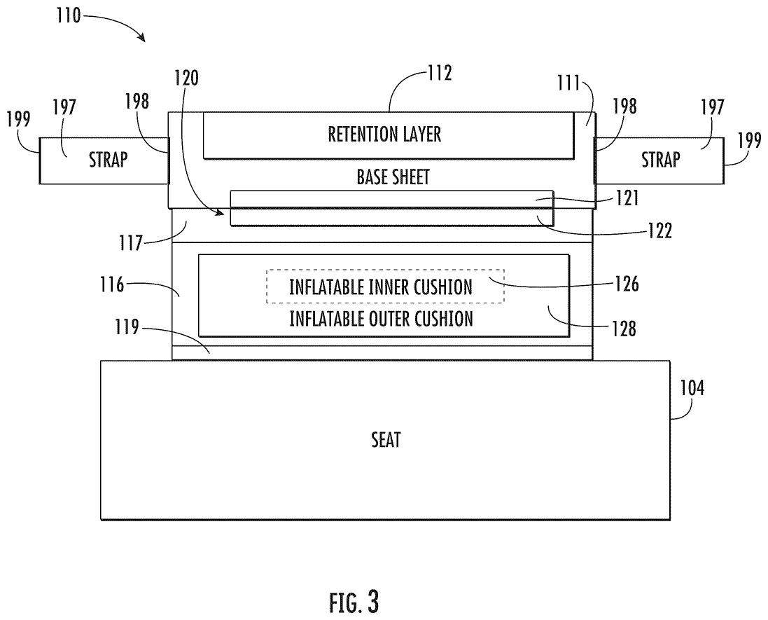

The base sheet 111 may include portions adjacent the retention layer 112 that are not covered by the retention layer 112 and are configured to contact the portion of the base sheet 111 contacted by the retention layer 112. The retention layer 112 may be constructed of, for example, polyester, nylon, foam, rubberized materials, silicone-infused fabrics, cotton, or other similar materials. The retention layer 112 may include, for example, a coating (e.g., a polyurethane coating, a polyvinyl chloride coating) to provide the second coefficient of friction. As shown in FIG. 3, the positioning system 110 also includes an inflatable cushion assembly 116. As is explained in more detail herein, the inflatable cushion assembly 116 is configured to provide a cushion (e.g., seat cushion, seat cover) on the seat 104 for the patient. In addition to increasing a comfort of the patient in using the chair 102, the inflatable cushion assembly 116 may mitigate pressure-related injuries to the patient (e.g., formation of pressure sores during prolonged use of the chair 102).

The inflatable cushion assembly 116 includes a top sheet 117. A bottom surface of the base sheet 111 is placed on the top sheet 117. In some embodiments, the top sheet 117 may be coupled to the bottom surface of the base sheet 111 and may extend from a bottom edge of the base sheet 111 towards a central portion of the base sheet 111. For example, the top sheet 117 may be coupled to the base sheet 111 via a stitch. As another example, the top sheet 117 may be coupled to the base sheet 111 via an adhesive (e.g., glue, etc.). As another example, the top sheet 117 may be removably coupled to the base sheet 111 via a fastener such as a button, snap, clip, zipper, hook-and-look fasteners, hook-and-eye fasteners, or other similar devices.

As shown in FIG. 2, the positioning system 110 includes a glide system 120 (e.g., one-way glide system). The glide system 120 is positioned between the base sheet 111 and the top sheet 117. The glide system 120 is configured to prevent movement of the base sheet 111 relative to the inflatable cushion assembly 116 as a patient is placed on the surface.

The glide system 120 includes a first glide sheet 121 (e.g., first glide strip, first glide material, etc.). The first glide sheet 121 coupled to the base sheet 111 via a stitch, adhesive, or similar attachment material. The first glide sheet 121 includes a material that has a third coefficient of friction. The material with the third coefficient of friction is configured to restrict movement of the base sheet 111 relative to the top sheet 117.

The glide system 120 includes a second glide sheet 122 (e.g., second glide strip, second glide material, etc.). The second glide sheet 122 is coupled to the top sheet 117 via a stitch, adhesive, or similar attachment material. The first glide sheet 121 includes a material that has a fourth coefficient of friction. The material with the fourth coefficient of friction is configured to restrict movement of the base sheet 111 relative to the top sheet 117. The material with the fourth coefficient of friction may include a material in which the fabric fibers (e.g. fabric protrusions) lift if brushed (e.g., brushed against) in a first direction. Conversely, the fabric fibers descend (e.g., are matted down, are smoothed out, become level) with the top sheet 117 when moved (e.g., brushed against) in a second direction, opposite the first direction. As an example, if the top sheet 117 shifts due to an external force (e.g., patient movement, nurse engagement with the positioning system 110), the first glide sheet 121 brushes against the second glide sheet 122, causing the fabric fibers to lift and engage with the first glide sheet 121. In some embodiments, the material with the fourth coefficient of friction may include moleskin fabric or material with similar properties.

When a patient is placed on the positioning system 110, the first glide sheet 121 and the second glide sheet 122 interact. The fabric fibers of the second glide sheet 122 engage with the first glide sheet 121 to prevent movement of the base sheet 111 and the top sheet 117 relative to one another (e.g., locking the base sheet 111 and the top sheet 117 in place).

The inflatable cushion assembly 116 also includes a bottom sheet 119. The bottom sheet 119 is positioned to receive the seat 104. The base sheet 111 is coupled to a first side of the top sheet 117, and the bottom sheet 119 is coupled to the second side of the top sheet 117.

The top sheet 117 and the bottom sheet 119 may be formed in similar shapes (e.g., geometrically similar shapes). As an example, the top sheet 117 and the bottom sheet 119 may be formed in a rounded rectangle. In some applications, the top sheet 117 and the bottom sheet 119 may be formed in a square, a rectangle, a circle, an oval, or a polygon. In some embodiments, the top sheet 117 is identical to the bottom sheet 119. In these embodiments, the top sheet 117 perfectly overlap and cooperates with the bottom sheet 119 to form the inflatable cushion assembly 116.

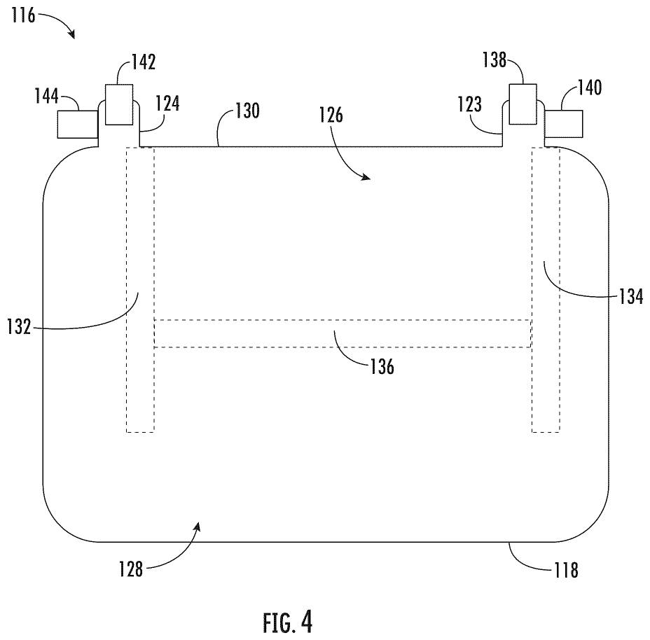

As shown in FIG. 4, the top sheet 117 includes a first tab 123 (e.g., projection). The first tab 123 extends from an edge of the top sheet 117 that is not covered by the retention layer 112. Similarly, the bottom sheet 119 includes a second tab 124 (e.g., projection). The second tab 124 extends from an edge of the bottom sheet 119 that is not covered by the retention layer 112. In some embodiments, the top sheet 117 includes the first tab 123 and the second tab 124. Similarly, the bottom sheet 119 may include the first tab 123 and the second tab 124. The first tab 123 is positioned on the top sheet 117 and the bottom sheet 119 may be sealed together, and the second tab 124 positioned on the top sheet 117 and the bottom sheet 119 may be sealed together, forming two double-layered tabs.

As shown in FIG. 4, the inflatable cushion assembly 116 includes an inflatable inner cushion 126. The inflatable inner cushion 126 is positioned along the first edge of the bottom sheet 119. The inflatable inner cushion 126 include the first tab 123. The inflatable inner cushion 126 is a substantially rectangular shape, configured to receive a portion of the sacrum and buttocks of the patient.

The inflatable cushion assembly 116 includes an inflatable outer cushion 128. The inflatable outer cushion 128 is positioned adjacent to the inflatable inner cushion 126 such that the inflatable outer cushion 128 is positioned between the periphery 118 of the bottom sheet 119 and the inflatable inner cushion 126, forming a polygon. The inflatable outer cushion 128 includes the second tab 124 on a first edge 130 of the bottom sheet 119. The inflatable outer cushion 128 is configured to receive a portion of the sacrum, the buttocks, and the lower extremities of the patient.

As shown in FIG. 4, the inflatable cushion assembly 116 includes formed regions. The formed regions define the boundary between the inflatable inner cushion 126 and the inflatable outer cushion 128. The formed regions may include sealing materials such as thermoplastic polymers, rubber, adhesives, welded seams, and/or various other materials. In some embodiments, the periphery 118 of the inflatable cushion assembly 116 as well as the formed regions are manufactured by heat sealing, radio frequency (RF) welding, ultrasonic welding, adhesive sealing, and/or various other processes.

The formed regions include a first formed region 132. The first formed region 132 extends a first distance from the first edge 130. For example, the first distance may equal half the width of the bottom sheet 119. As another example, the first distance may equal less than half the width of the bottom sheet 119. As another example, the first distance may equal greater than half the width of the bottom sheet 119.

The formed regions include a second formed region 134. The second formed region 134 extends a second distance from the first edge 130. The second distance is substantially equal in length to the first distance. For example, the second distance may equal half the width of the bottom sheet 119. As another example, the second distance may equal less than half the width of the bottom sheet 119. As another example, the second distance may equal greater than half the width of the bottom sheet 119.

The formed regions may include a third formed region 136. The third formed region 136 defines the horizontal boundary between the inflatable inner cushion 126 and the inflatable outer cushion 128. The third formed region 136 extends a third distance to connect the first formed region 132 and the second formed region 134. For example, the third distance may equal half the length of the bottom sheet 119. As another example, the third distance may equal less than half the length of the bottom sheet 119. As another example, the second distance may equal greater than half the length of the bottom sheet 119.

In various embodiments, the first tab 123 is continuous with the top sheet 117 and the second tab 124 is continuous with the bottom sheet 119. In some embodiments, the top sheet 117 includes both the first tab 123 and second tab 124, and the bottom sheet 119 includes both the first tab 123 and the second tab 124. In these embodiments, the top sheet 117 and the bottom sheet 119 are two continuous, distinct sheets of material.

In some embodiments, the top sheet 117 and the bottom sheet 119 are formed from the same material. However, in some applications, the top sheet 117 and the bottom sheet 119 are formed from materials with different coefficients of friction. For example, one of the top sheet 117 or the bottom sheet 119 may be formed from a material with a relatively low coefficient of friction and the other of the top sheet 117 or the bottom sheet 119 may be formed from a material with a relatively high coefficient of friction. For example, each of the top sheet 117 and the bottom sheet 119 may be made from nylon, polyester, HDPE, polypropylene, cotton, or other similar materials.

As shown in FIG. 4, the inflatable cushion assembly 116 includes a first one-way valve 138 (e.g., check valve). The first one-way valve 138 is coupled to the first tab 123. The first one-way valve 138 is in fluid communication with the inflatable inner cushion 126 and is configured to facilitate entrance of fluid into the inflatable inner cushion 126. In some embodiments, the fluid is a gas. For example, the fluid may include gases such as atmospheric air, medical grade air, nitrogen, carbon dioxide, or other similar gases.

In some embodiments, the inflatable cushion assembly 116 includes a first pressure-relief valve 140 (e.g., a first purge valve) that is coupled to the first tab 123 and first one-way valve 138. The first pressure-relief valve 140 is configured to open and release the fluid when a pressure of the fluid within the inflatable inner cushion 126 is at a target pressure of the inflatable inner cushion 126. In this way, the first pressure-relief valve 140 protects the inflatable cushion assembly 116 (e.g., against undesirable over pressurization). Additionally, the first pressure-relief valve 140 may facilitate selective release of the fluid within the inflatable inner cushion 126 to tailor a pressure of the fluid within the inflatable inner cushion 126 to a target pressure such that the inflatable cushion assembly 116 is tailored for a target application. For example, after inflating the inflatable inner cushion 126, a nurse may manipulate the first pressure-relief valve 140 to release some of the fluid such that the inflatable inner cushion 126 is tailored for a target application.

As shown in FIG. 4, the inflatable cushion assembly 116 includes a second one-way valve 142 (e.g., check valve). The second one-way valve 142 is coupled to the second tab 124. The second one-way valve 142 is in fluid communication with the inflatable outer cushion 128 and is configured to facilitate entrance of fluid into the inflatable outer cushion 128. In some embodiments, the fluid is a gas. For example, the fluid may include gases such as atmospheric air, medical grade air, nitrogen, carbon dioxide, or other similar gases.

In some embodiments, the inflatable cushion assembly 116 includes a second pressure-relief valve 144 (e.g., a second purge valve) that is coupled to the second tab 124 and second one-way valve 142. The second pressure-relief valve 144 is configured to open and release the fluid when a pressure of the fluid within the inflatable outer cushion 128 is at a target pressure of the inflatable outer cushion 128. In this way, the second pressure-relief valve 144 protects the inflatable cushion assembly 116 (e.g., against undesirable over pressurization). Additionally, the second pressure-relief valve 144 may facilitate selective release of the fluid within the inflatable outer cushion 128 to tailor a pressure of the fluid within the inflatable outer cushion 128 to a target pressure such that the inflatable cushion assembly 116 is tailored for a target application. For example, after inflating the inflatable outer cushion 128 a nurse may manipulate the second pressure-relief valve 144 to release some of the fluid such that the inflatable outer cushion 128 is tailored for a target application.

In some embodiments, at least one of the first one-way valve 138 or the second one-way valve 142 is replaced with a two-way valve. The two-way valve may enable the inflatable cushion assembly 116 to be deflated (e.g., for storage of the positioning system 110). For example, a vacuum may be connected to such a two-way valve to draw fluid from the inflatable cushion assembly 116 and minimize a volume of the inflatable cushion assembly 116.

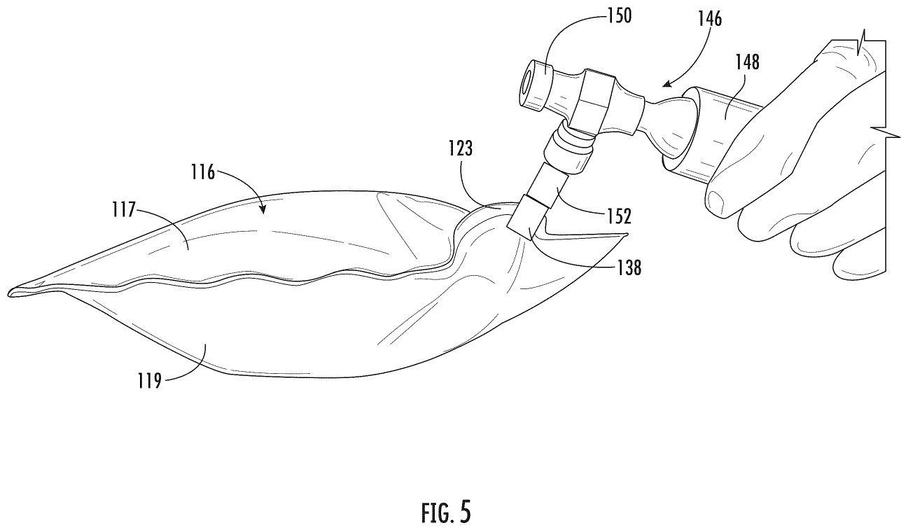

FIG. 5 illustrates a nurse inflating the inflatable cushion assembly 116. In some embodiments, the inflatable cushion assembly 116 is shown as receiving a fluid via the first one-way valve 138 to inflate the inflatable inner cushion 126. While not shown in FIG. 5, the inflatable cushion assembly 116 receives the fluid via the second one-way valve 142 to inflate the inflatable outer cushion 128. Inflation of the inflatable cushion assembly 116 is performed during assembly of the positioning system 110. For example, before a patient is supported using the positioning system, the inflatable cushion assembly 116 is inflated.

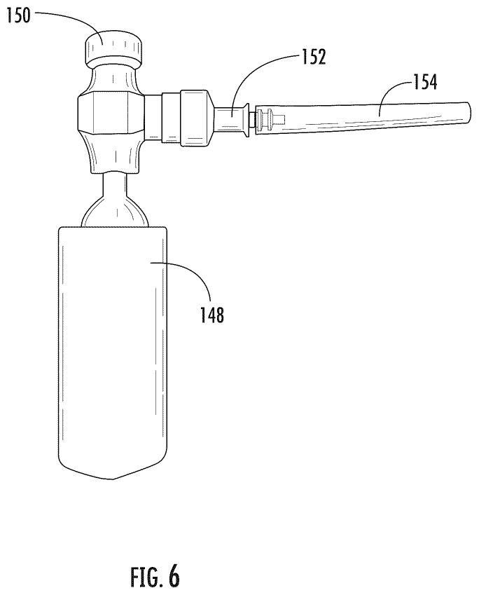

As shown in FIG. 6, the seated positioning system 100 includes an air cannister 146. The fluid is held in the air cannister 146. The air cannister 146 is used to perform inflation of the inflatable cushion assembly 116 during assembly of the positioning system 110. The air cannister 146 includes a body 148, a valve assembly 150, an adaptor 152, and tubing 154. The valve assembly 150 includes a main valve, a pressure relief valve, and a release configured to facilitate operation (e.g., opening, closing) of the main valve. The release may include, for example, a push button, a twist cap, a pull tab, or a plunger.

To dispense the fluid into the inflatable cushion assembly 116 using the air cannister 146, the adaptor 152 attaches to (e.g., screws) onto the air cannister 146. The adaptor 152 attaches to the tubing 154 and is inserted into the first one-way valve 138 to fill the inflatable inner cushion 126. The release of the valve assembly 150 allows fluid from the air cannister 146 to enter the inflatable inner cushion 126. The tubing 154 is then inserted into the second one-way valve 142 to fill the inflatable outer cushion 128. The release of the valve assembly 150 allows fluid from the air cannister 146 to enter the inflatable outer cushion 128.

When a predetermined volume dictated by the size of the inflatable cushion assembly 116 is achieved, the tubing 154 is removed from either the first one-way valve 138 or the second one-way valve 142. As a result, the inflatable inner cushion 126 and the inflatable outer cushion 128 remain inflated for use with a patient. If the volume of fluid dispensed into the inflatable cushion assembly 116 exceeds operating capacity (e.g., inflatable cushion assembly 116 is overfilled), the fluid may be released via the first pressure-relief valve 140 or the second pressure-relief valve 144. In some embodiments, the air cannister 146 may include an additional pressure relief valve configured to release fluid from the inflatable cushion assembly 116 in the event the volume exceeds operating capacity.

In some embodiments, the inflatable cushion assembly 116 inflates via a pull tab, as described below. The inflatable inner cushion 126 may include two pull tabs, where a first pull tab is located at the first one-way valve 138 and a second pull tab is located at the second one-way valve 142. The air cannister 146 may be attached to the first pull tab and the second pull tab via an adhesive, a threaded valve, or similar connection. The air cannister 146 may contain a predetermined volume of fluid to prevent exceeding operating capacity. To inflate the inflatable inner cushion 126, a nurse may engage with the first pull tab and the second pull tab (e.g., pulling the first pull tab and the second pull tab in a direction perpendicular from the first edge 130), which may puncture an opening of each air cannister 146. As a result, each air cannister 146 may dispense the fluid into the inflatable cushion assembly 116, therefore inflating the inflatable inner cushion 126 and inflatable outer cushion 128.

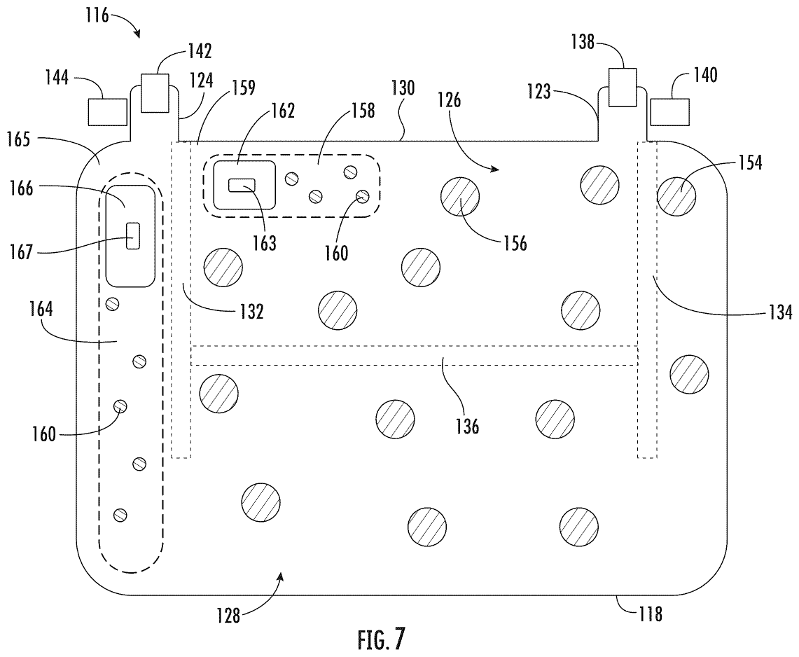

FIG. 7 illustrates another embodiment of the inflatable cushion assembly 116. In this embodiment, the inflatable cushion assembly 116 is inflated via a chemical reaction that is initiated by a nurse. The chemical reaction produces a gaseous byproduct within the inflatable inner cushion 126 and the inflatable outer cushion 128. The chemical reaction may include a synthesis reaction, a single replacement reaction, a double replacement reaction, an acid-base reaction, or another similar chemical reaction.

To facilitate the chemical reaction, at least a portion of an interior surface of the top sheet 117 and at least a portion of an interior surface of the bottom sheet 119 are coated with a first reactant 156. For example, the first reactant 156 may be applied to the top sheet 117 and the bottom sheet 119 during manufacture of the inflatable cushion assembly 116. In one example, the at least a portion of the interior surface of the top sheet 117 coated with the first reactant 156 faces the at least a portion of the interior surface of the bottom sheet 119.

In some embodiments, the first reactant 156 includes sodium bicarbonate present as a solid form such as a dispersed powder or a pellet, or a semi-solid form. The first reactant may be enclosed between the top sheet 117 and the bottom sheet 119 during manufacture of the inflatable cushion assembly 116. In some applications, a total volume of the first reactant 156 includes 2-50 grams of sodium bicarbonate. In other applications, a total volume of the first reactant 156 includes 12-30 grams of sodium bicarbonate. In other applications, the first reactant 156 may include a metal, an ionic compound, a salt, an acid, or a base.

To facilitate the chemical reaction, the inflatable inner cushion 126 includes a first reservoir 158. The first reservoir 158 is positioned at a first interior surface 159 of the inflatable inner cushion 126 and encloses a second reactant 160. In some applications, the first reservoir 158 has a cylindrical shape. In other applications, the first reservoir 158 may have a polygonal shape. The first reservoir 158 is configured to prevent ingress of the first reactant into the first reservoir 158 prior to bursting of the first reservoir 158. To do so, the first reservoir 158 is constructed of a durable material. For example, the first reservoir 158 is constructed with polyurethane thermoplastic. As another example, the first reservoir 158 is constructed of polyurethane, polyamide, polypropylene, polyethylene, polyvinyl chloride, ethylene vinyl acetate copolymer, polyether block amide polymers, silicone, and/or similar materials.

In some embodiments, the second reactant 160 may include a citric acid solution dissolved in an aqueous media. In some embodiments, a total volume of the second reactant 160 includes 5-100 grams of citric acid. In some embodiments, a total volume of the second reactant 160 includes 25-60 grams of citric acid. It should be understood that the embodiment is not limited to the described reactants herein as other metals, ionic compounds, salts, acids, or bases may be used.

The aqueous media includes water. In some applications, the aqueous media may include buffers (e.g., citrate, phosphate, acetate) to stabilize the pH of the media. In other applications, the aqueous media may include stabilizers (e.g., antioxidants, chelating agents) to prevent degradation and maintain the desired chemical properties of the citric acid solution. In other embodiments, the aqueous media may include preservatives (e.g., benzoates, sorbates, parabens, sulfates, alcohols) to prevent microbial growth.

To facilitate the chemical reaction, a first activator 162 is positioned over the first reservoir 158. The first activator 162 is configured to pierce the reservoir when a first force is applied to the first activator 162. In some embodiments, the first activator 162 may be coupled to an interior face of the top sheet 117. In some embodiments, the first activator 162 may be coupled to the interior surface of the bottom sheet 119. In some embodiments, the first activator 162 may be coupled to the first reservoir 158.

In some embodiments, the first activator 162 is a first protrusion 163 (e.g., needle, prong, spike, nail). The first protrusion 163 is configured to pierce the first reservoir 158 when a first force is applied to the first activator 162. In some applications, the first protrusion 163 may include a groove composed of a rigid material. The rigid material be constructed of polymers, metals, ceramics, or similar materials.

To facilitate the chemical reaction, the inflatable outer cushion 128 includes a second reservoir 164. The second reservoir 164 is positioned at a second interior surface 165 of the inflatable outer cushion 128 and encloses a second reactant 160. In some applications, the second reservoir 164 has a cylindrical shape. In other applications, the second reservoir 164 may have a polygonal shape. The second reservoir 164 is configured to prevent ingress of the first reactant 156 into the second reservoir 164 prior to bursting of the second reservoir 164. To do so, the second reservoir 164 is constructed of a durable material. For example, the second reservoir 164 is constructed with polyurethane thermoplastic. As another example, the second reservoir 164 is constructed of polyurethane, polyamide, polypropylene, polyethylene, polyvinyl chloride, ethylene vinyl acetate copolymer, polyether block amide polymers, silicone, and/or similar materials.

To facilitate the chemical reaction, a second activator 166 is positioned over the second reservoir 164. The second activator 166 is configured to pierce the reservoir when a first force is applied to the second activator 166. In some embodiments, the second activator 166 may be coupled to an interior face of the top sheet 117. In some embodiments, the second activator 166 may be coupled to the interior surface of the bottom sheet 119. In some embodiments, the second activator 166 may be coupled to the second reservoir 164.

In some embodiments, the second activator 166 is a second protrusion 167 (e.g., needle, prong, spike, nail). The second protrusion 167 is configured to pierce the second reservoir 164 when a first force is applied to the second activator 166. In some applications, the second protrusion 167 may include a groove composed of a rigid material. The rigid material be constructed of polymers, metals, ceramics, or similar materials.

To facilitate the chemical reaction in the inflatable inner cushion 126, a user applies a first force to the first activator 162 at the first reservoir 158. In some embodiments, the force may be applied by the strike of a fist, elbow, or foot. In some embodiments, the force may be applied using an external device such as a hammer (e.g., claw, ball-peen, reflex), a mallet, or similar instrument. In some applications, the first activator 162 and the first reservoir 158 are configured such that the force required to cause the first protrusion 163 to pierce the first reservoir 158 is between approximately 20 pounds and approximately 200 pounds. For example, the force required to cause the first protrusion 163 to pierce the first reservoir 158 may be approximately 80 pounds. As another example, the force required to cause the first protrusion 163 to pierce the first reservoir 158 may be approximately 120 pounds. In other applications, the first activator 162 and the first reservoir 158 are configured such that the force required to cause the first protrusion 163 to pierce the first reservoir 158 is between approximately 40 pounds and approximately 60 pounds. For example, the force required to cause the first protrusion 163 to pierce the first reservoir 158 may be approximately 50 pounds.

As the first reservoir 158 is pierced, the second reactant 160 releases. The second reactant 160 enters the body of the inflatable inner cushion 126, therefore contacting the first reactant 156 to initiate the chemical reaction. The chemical reaction therefore produces a first gaseous product which inflates the inflatable inner cushion 126. For example, the chemical reaction between the citric acid solution and sodium bicarbonate may lead to rapid formation of carbon dioxide gas. In some embodiments, the chemical reaction may produce several gaseous products configured to fill the inflatable cushion assembly 116.

To facilitate the chemical reaction in the inflatable outer cushion 128, a user applies a first force to the second activator 166 at the second reservoir 164. In some embodiments, the force may be applied by the strike of a fist, elbow, or foot. In some embodiments, the force may be applied using an external device such as a hammer (e.g., claw, ball-peen, reflex), a mallet, or similar instrument. In some applications, the second activator 166 and the second reservoir 164 are configured such that the force required to cause the second protrusion 167 to pierce the second reservoir 164 is between approximately 20 pounds and approximately 200 pounds. For example, the force required to cause the second protrusion 167 to pierce the second reservoir 164 may be approximately 80 pounds. As another example, the force required to cause the second protrusion 167 to pierce the second reservoir 164 may be approximately 120 pounds. In other applications, the second activator 166 and the second reservoir 164 are configured such that the force required to cause the second protrusion 167 to pierce the second reservoir 164 is between approximately 40 pounds and approximately 60 pounds. For example, the force required to cause the second protrusion 167 to pierce the second reservoir 164 may be approximately 50 pounds.

As the second reservoir 164 is pierced, the second reactant 160 releases. The second reactant 160 enters the body of the inflatable outer cushion 128, therefore contacting the first reactant 156 to initiate the chemical reaction. The chemical reaction therefore produces a first gaseous product which inflates the inflatable outer cushion 128. For example, the chemical reaction between the citric acid solution and sodium bicarbonate may lead to rapid formation of carbon dioxide gas. In some embodiments, the chemical reaction may produce several gaseous products configured to fill the inflatable cushion assembly 116.

In some applications, the inflatable cushion assembly 116 is configured to complete inflation to a volume within operating capacity within 30 seconds to 30 minutes. In other applications, the inflatable cushion assembly 116 is configured to complete inflation to a volume within operating capacity within 1 minute to 3 minutes.

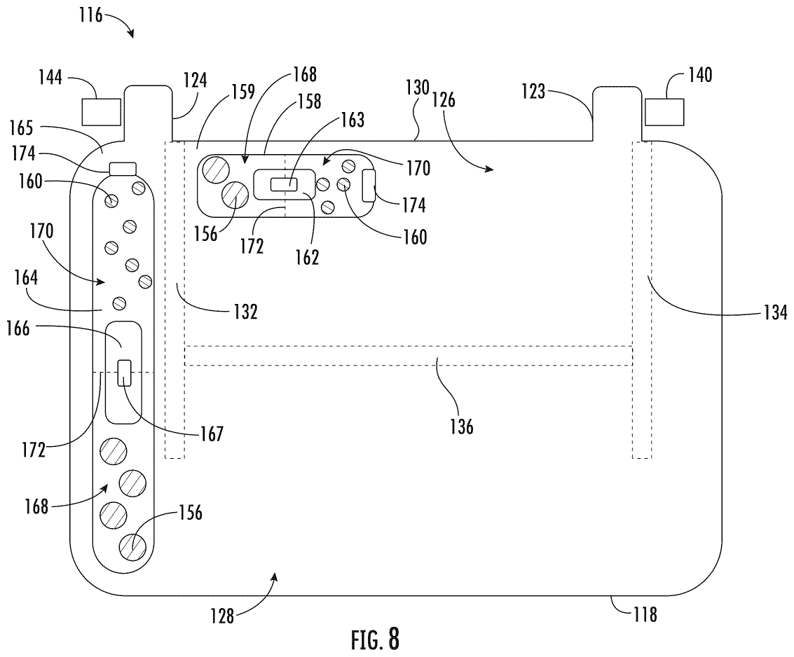

FIG. 8 illustrates another embodiment of the inflatable cushion assembly 116. In this embodiment, the inflatable inner cushion 126 is inflated via a chemical reaction within the first reservoir 158 that is initiated by a user. The inflatable outer cushion 128 is inflated via a chemical reaction within the second reservoir 164 that is initiated by a user. The chemical reaction produces a first gaseous product. The first gaseous product is released into the inflatable inner cushion 126 and the inflatable outer cushion 128 to inflate the inflatable cushion assembly 116. The chemical reaction may include a synthesis reaction, a single replacement reaction, a double replacement reaction, an acid-base reaction, or another similar chemical reaction.

In some embodiments, the first reactant 156 includes water, and the second reactant 160 includes a mixture of ammonium chloride and sodium nitrite solid powders to form nitrogen gas via a double replacement reaction. It should be understood that the embodiment is not limited to the described reactants herein as other metals, ionic compounds, salts, acids, or bases may be used.

To facilitate the chemical reaction, the first reservoir 158 further includes a first reservoir chamber 168 and a second reservoir chamber 170. The first reservoir chamber 168 contains the first reactant 156. The second reservoir chamber 170 contains the second reactant 160.

In some embodiments, the first reservoir 158 may further includes a barrier 172 extending across the interior walls of each reservoir to create two distinct environments. The barrier 172 is configured to open upon applying pressure to the first activator 162 at the first protrusion 163. For example, the barrier 172 may include a durable material constructed with polyurethane thermoplastic. As another example, the first reservoir 158 is constructed of polyurethane, polyamide, polypropylene, polyethylene, polyvinyl chloride, ethylene vinyl acetate copolymer, polyether block amide polymers, silicone, and/or similar materials.

In some embodiments, the first reservoir 158 may further include an outlet 174 configured to open upon pressure of a gaseous product generated from the chemical reaction. The outlet 174 is in fluid communication with the second reservoir chamber 170. In some applications, the outlet 174 is a pressure relief valve. The outlet 174 opens automatically when gas pressure of the first reservoir 158 exceeds a preset level, allowing the gas to fill the inflatable inner cushion 126. In other applications, the outlet 174 is a cover including a selectively permeable material. The selectively permeable material extends over a portion of the first reservoir 158 to facilitate flow of gas but restrict flow of liquid or solid products into the inflatable cushion assembly 116. As an example, the outlet 174 includes a material such as polytetrafluoroethylene (PTFE), polyvinylidene fluoride (PVDF), nylon, polypropylene, polyurethane, or similar materials.

To facilitate the chemical reaction, the second reservoir 164 further includes a first reservoir chamber 168 and a second reservoir chamber 170. The first reservoir chamber 168 contains the first reactant 156. The second reservoir chamber 170 contains the second reactant 160.

In some embodiments, the second reservoir 164 may further includes a barrier 172 extending across the interior walls of each reservoir to create two distinct chambers. The barrier 172 is configured to open upon applying pressure to the second activator 166 at the second protrusion 167. For example, the barrier 172 may include a durable material constructed with polyurethane thermoplastic. As another example, the second reservoir 164 is constructed of polyurethane, polyamide, polypropylene, polyethylene, polyvinyl chloride, ethylene vinyl acetate copolymer, polyether block amide polymers, silicone, and/or similar materials.

In some embodiments, the second reservoir 164 may further include an outlet 174 configured to open upon pressure of a gaseous product generated from the chemical reaction. The outlet 174 is in fluid communication with the second reservoir chamber 170. In some applications, the outlet 174 is a pressure relief valve. The outlet 174 opens automatically when gas pressure of the second reservoir 164 exceeds a preset level, allowing the gas to fill the inflatable outer cushion 128. In other applications, the outlet 174 is a cover including a selectively permeable material. The selectively permeable material extends over a portion of the second reservoir 164 to facilitate flow of gas but restrict flow of liquid or solid products into the inflatable cushion assembly 116. As an example, the outlet 174 includes a material such as polytetrafluoroethylene (PTFE), polyvinylidene fluoride (PVDF), nylon, polypropylene, polyurethane, or similar materials.

To facilitate the chemical reaction in the inflatable inner cushion 126, a user applies a force to the first activator 162 at the first protrusion 163. In some embodiments, the force may be applied by the strike of a fist, elbow, or foot. In some embodiments, the force may be applied using an external device such as a hammer (e.g., claw, ball-peen, reflex), a mallet, or similar instrument. In some applications, the force generated to initiate the first protrusion 163 to pierce the first reservoir 158 is between approximately 20 pounds and approximately 200 pounds. For example, the force required to cause the first protrusion 163 to pierce the first reservoir 158 may be approximately 80 pounds. As another example, the force required to cause the first protrusion 163 to pierce the first reservoir 158 may be approximately 120 pounds. In other applications, the first activator 162 and the first reservoir 158 are configured such that the force required to cause the first protrusion 163 to pierce the first reservoir 158 is between approximately 40 pounds and approximately 60 pounds. For example, the force required to cause the first protrusion 163 to pierce the first reservoir 158 may be approximately 50 pounds.

As force is applied to each first activator 162, the first protrusion 163 pierces the barrier 172. The barrier 172 opens, allowing the first reactant 156 housed within the first reservoir chamber 168 to enter the second reservoir chamber 170. The first reactant 156 contacts the second reactant 160 to initiate the chemical reaction and produce a first gaseous product. When the pressure of the first reservoir 158 exceeds the preset level determined by the outlet 174, the outlet 174 opens, releasing the gas into the inflatable inner cushion 126 to fill the inflatable cushion assembly 116.

To facilitate the chemical reaction in the inflatable outer cushion 128, a user applies a force to the second activator 166 at the second protrusion 167. In some embodiments, the force may be applied by the strike of a fist, elbow, or foot. In some embodiments, the force may be applied using an external device such as a hammer (e.g., claw, ball-peen, reflex), a mallet, or similar instrument. In some applications, the force generated to initiate the second protrusion 167 to pierce the second reservoir 164 is between approximately 20 pounds and approximately 200 pounds. For example, the force required to cause the second protrusion 167 to pierce the second reservoir 164 may be approximately 80 pounds. As another example, the force required to cause the second protrusion 167 to pierce the second reservoir 164 may be approximately 120 pounds. In other applications, the second activator 166 and the second reservoir 164 are configured such that the force required to cause the second protrusion 167 to pierce the second reservoir 164 is between approximately 40 pounds and approximately 60 pounds. For example, the force required to cause the second protrusion 167 to pierce the second reservoir 164 may be approximately 50 pounds

As force is applied to each second activator 166, the second protrusion 167 pierces the barrier 172. The barrier 172 opens, allowing the first reactant 156 housed within the first reservoir chamber 168 to enter the second reservoir chamber 170. The first reactant 156 contacts the second reactant 160 to initiate the chemical reaction and produce a first gaseous product. When the pressure of the second reservoir 164 exceeds the preset level determined by the outlet 174, the outlet 174 opens, releasing the gas into the inflatable outer cushion 128 to fill the inflatable cushion assembly 116.

As an example, the chemical reaction between the water and mixture of ammonium chloride and sodium nitrite solid powders form nitrogen gas. When pressure of the first reservoir 158 exceeds the preset level determined by the outlet 174, the outlet 174 opens, allowing nitrogen gas to inflate the inflatable inner cushion 126 to a volume within operating capacity. When pressure of the second reservoir 164 exceeds the preset level determined by the outlet 174, the outlet 174 opens, allowing nitrogen gas to inflate the inflatable outer cushion 128 to a volume within operating capacity.

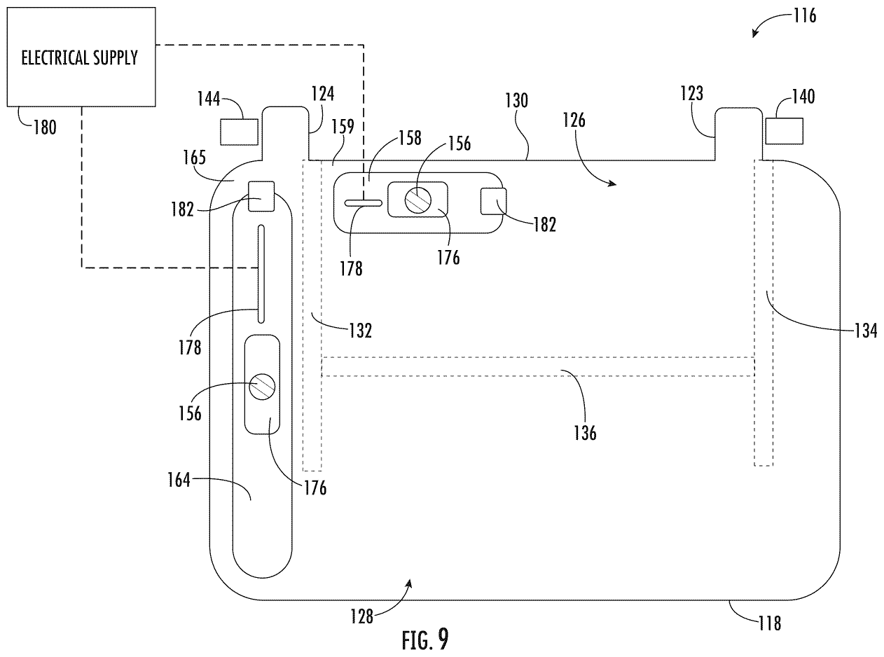

FIG. 9 illustrates another embodiment of the inflatable cushion assembly 116. In this embodiment, the inflatable cushion assembly 116 inflates via a chemical reaction provoked by an electrical signal. The chemical reaction produces a first gaseous product within the first reservoir 158 which is released into the inflatable inner cushion 126 to inflate the inflatable cushion assembly 116. The chemical reaction produces a second gaseous product within the second reservoir 164 which is released into the inflatable outer cushion 128 to inflate the inflatable cushion assembly 116. The chemical reaction may include a synthesis reaction, a single replacement reaction, a double replacement reaction, an acid-base reaction, or another similar chemical reaction.

As an example, the first reactant 156 includes sodium azide. The sodium azide decomposes to form nitrogen gas via a decomposition reaction. It should be understood that the embodiment is not limited to the described reactants herein as other metals, ionic compounds, salts, acids, or bases may be used. In some applications, the first gaseous product and the second gaseous product may have the same composition. In other applications, the first gaseous product and the second gaseous product may have distinct compositions.

To facilitate the chemical reaction, the first reservoir 158 is metal case with a combustion chamber 176. The combustion chamber 176 contains a solid fuel (e.g., the first reactant 156) pressed into a tablet. In some embodiments, the solid fuel may be present as a solid form such as a dispersed powder or a pellet, or a semi-solid form.

To facilitate the chemical reaction, the first reservoir 158 further includes an explosive device 178. The explosive device 178 is a triggering wire containing a gun powder-based explosive material. In some embodiments, the explosive device 178 may extend from the first reservoir 158 to the exterior of the inflatable cushion assembly 116.

To facilitate the chemical reaction, the second reservoir 164 is metal case with a combustion chamber 176. The combustion chamber 176 contains a solid fuel (e.g., the first reactant 156) pressed into a tablet. In some embodiments, the solid fuel may be present as a solid form such as a dispersed powder or a pellet, or a semi-solid form.

To facilitate the chemical reaction, the second reservoir 164 further includes an explosive device 178. The explosive device 178 is a triggering wire containing a gun powder-based explosive material. In some embodiments, the explosive device 178 may extend from the second reservoir 164 to the exterior of the inflatable cushion assembly 116.

To facilitate the chemical reaction in the inflatable inner cushion 126, a user connects the first reservoir 158 to an electrical supply 180. In some embodiments, the electrical supply 180 may be a battery. In some embodiments, the electrical supply 180 may include an electrical outlet.

Following the connection, the electrical supply 180 ignites the explosive device 178 within the first reservoir 158 electronically. Upon receiving an electrical signal, the burn-off produced from the explosive device 178 initiates the decomposition reaction, producing a first gaseous product. The first gaseous product passes through the cooling unit 182 to decrease the temperature of the first gaseous product. The first gaseous product releases into the inflatable inner cushion 126 to fill the inflatable cushion assembly 116.

To facilitate the chemical reaction in the inflatable outer cushion 128, a user connects the second reservoir 164 to an electrical supply 180. In some embodiments, the electrical supply 180 may be a battery. In some embodiments, the electrical supply 180 may include an electrical outlet.

Following the connection, the electrical supply 180 ignites the explosive device 178 within the second reservoir 164 electronically. Upon receiving an electrical signal, the burn-off produced from the explosive device 178 initiates the decomposition reaction, producing a second gaseous product. The first gaseous product passes through the cooling unit 182 to decrease the temperature of the second gaseous product. The first gaseous product releases into the inflatable outer cushion 128 to fill the inflatable cushion assembly 116.

As an example, the ignition of the explosive device 178 initiates the decomposition of sodium azide within the first reservoir 158, producing nitrogen gas. The ignition of the explosive device 178 initiates the decomposition of sodium azide within the second reservoir 164, producing nitrogen gas. The nitrogen gas passes through the cooling unit 182 before filling the inflatable cushion assembly 116 to a volume within operating capacity.

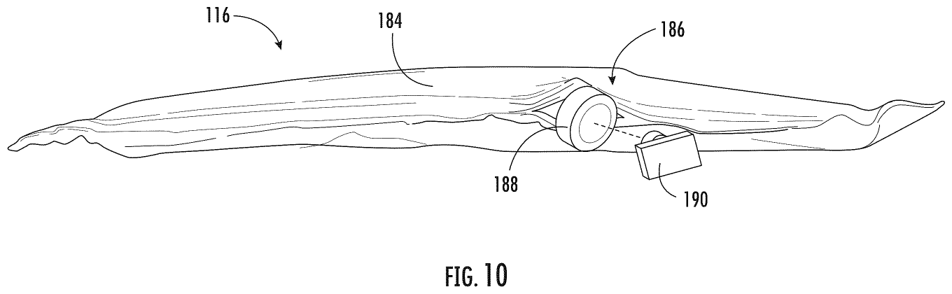

FIG. 10 illustrates another embodiment of the inflatable cushion assembly 116. The inflatable cushion assembly 116 is filled with compressed foam configured to expand upon engagement with the positioning system 110. The foam 184 is open cell foam held in a compressed state via a vacuum seal. The volume of the foam 184 is five times to fifteen times smaller in the compressed state in comparison to an expanded state. The vacuum seal may be accomplished by an external vacuum during manufacturing.

In some embodiments, the inflatable inner cushion 126 and the inflatable outer cushion 128 are filled with foam 184 that is substantially equal in thickness. In some embodiments, the foam 184 within the inflatable inner cushion 126 may have a greater thickness than that of the inflatable outer cushion 128 to support the sacrum. In some embodiments, the foam 184 within the inflatable outer cushion 128 may have a greater thickness than that of the inflatable inner cushion 126 to cradle the patient and prevent slipping in a forward direction when placed on the positioning system 110.

In some embodiments, the inflatable cushion assembly 116 includes an adaptor assembly 186. The adaptor assembly 186 is positioned along the first edge 130 of the bottom sheet 119 at the first tab 123 and the second tab 124. The adaptor assembly 186 includes a valve 188 and a cap 190. For example, the adaptor assembly 186 may include a threaded cap, a push-on cap, snap-on cap, flanged cap, or similar sealing mechanism. As another example, the adaptor assembly 186 may include a cap-valve assembly where the cap 190 is attached to the valve 188 and facilitates movement of fluid in the inflatable cushion assembly 116 when twisted to an open state. In some embodiments, an adaptor assembly 186 may be positioned along each outer edge of the bottom sheet 119 to optimize influx of air.

To facilitate expansion, the cap 190 is removed from the valve 188 of the adaptor assembly 186. In doing so, air from the surrounding environment enters the inflatable cushion assembly 116 via the adaptor assembly 186 and begins to fill the compressed open cell foam. As a result, the open cell foam expands to a volume five times to fifteen times greater than its compressed state, thereby inflating the inflatable inner cushion 126 and the inflatable outer cushion 128.

In some embodiments, a one-way valve may be positioned along the outer edge of the bottom sheet 119, in which the user (e.g., nurse, doctor, healthcare provider) may insert tubing into the one-way valve to allow the entrance of air into the inflatable cushion assembly 116. In some embodiments, the inflatable cushion assembly 116 may be shrink-wrapped or tightly enclosed without the use of an adaptor assembly 186 and expand over time once a user (e.g., nurse, doctor, healthcare provider) unpackages the inflatable cushion assembly 116.

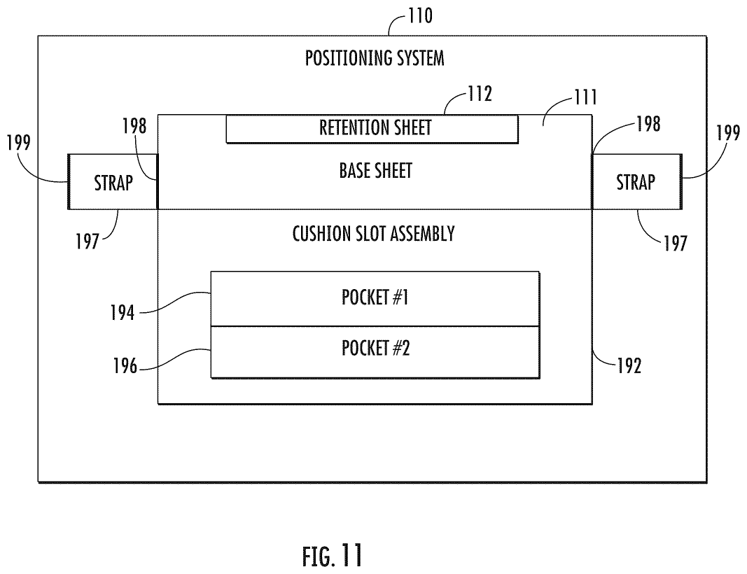

FIG. 11 illustrates the positioning system 110 with the inflatable cushion assembly 116 replaced with a cushion slot assembly 192. The cushion slot assembly 192 includes a first slot 194 (e.g., sleeve). The first slot 194 is configured to hold a device (e.g., cushion, pillow, foam inserts, chair alarm). Additionally, in some embodiments, the device held by the first slot 194 is the inflatable cushion assembly 116. The first slot 194 may include similar materials to that of the base sheet 111. In some embodiments, the first slot 194 may include one layer of material coupled to the bottom of the base sheet 111 on three outer edges. The fourth outer edge is unbound and includes an engagement region. For example, the engagement region may include Velcro, zippers, slider closure, a flap, or similar attachment materials. The engagement region is configured to secure the device within the first slot 194.

In some embodiments, the cushion slot assembly 192 includes a first slot 194 (e.g., a first pocket) and a second slot 196 (e.g., second pocket). The first slot 194 and the second slot 196 is composed of two additional layers of material are coupled to the bottom of the base sheet 111 on three outer edges. The fourth outer edge is unbound and includes the engagement region. In some embodiments, the second pocket may be coupled to an edge of the first slot 194. The cushion slot assembly 192 is then configured to unfold, allowing the first slot 194 to support the patient's sacrum, buttocks, and lower extremities, while the second slot 196 supports on the patient's lower torso at the back 106.

Referring back to FIG. 1-3, the positioning system 110 includes a strap 197. The strap 197 is an elongated piece of material that includes a first end 198 and a second end 199. The first end 198 is stitched to a longitudinal edge of the inflatable cushion assembly 116. The second end 199 is free and includes at least one handle (e.g., loop). The positioning system 110 may include at least two straps where a first end 198 of each strap 197 is stitched to each of the longitudinal edges of the inflatable cushion assembly 116. In some embodiments, the strap 197 may be constructed of a woven material. In some embodiments, the strap 197 may be constructed of nylon, polyester, rubber/silicone, canvas, or other similar materials. The strap 197 is configured to facilitate rearward movement by grasping and pulling on the strap 197 towards the back 106. The strap 197 are configured to facilitate frontward movement by grasping and pulling on the strap 197 away from the back 106.

In some embodiments, various types of positions or orientations of the handles may be utilized dependent on the size and weight capacity of the positioning system 110. In some embodiments, the strap 197 may include Velcro, zippers, slider closure, a flap, or similar attachment materials to secure the strap 197 together when bound around the chair 102. In some embodiments, the strap 197 may be secured to the arms 108 to stabilize the positioning system 110. In some embodiments, the strap 197 may be secured around the bottom of the seat 104 to stabilize the positioning system 110. In some embodiments, the strap 197 may be secured around the back 106 to stabilize the positioning system 110.

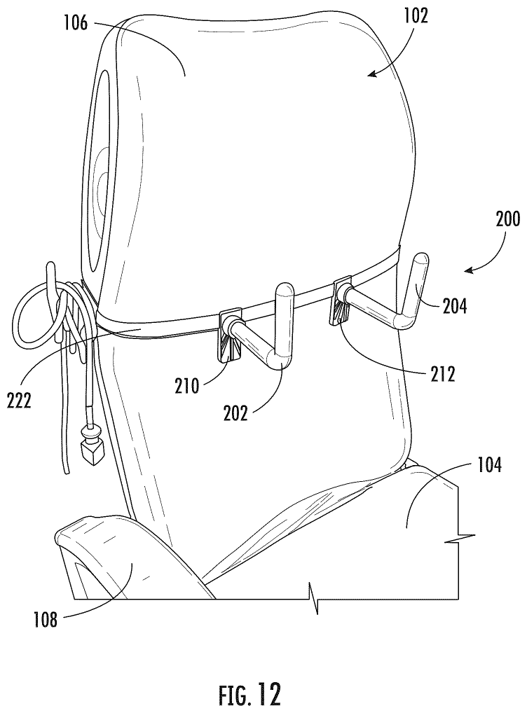

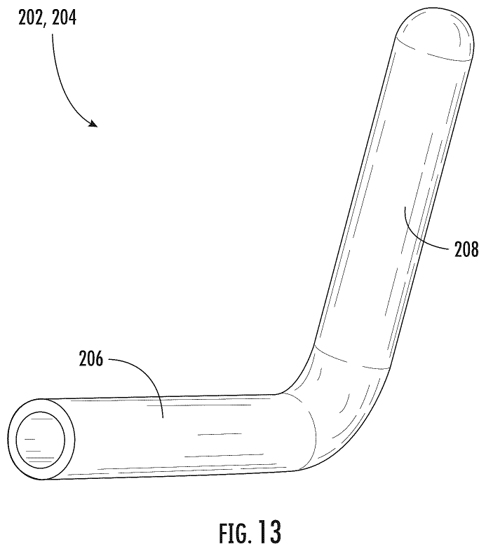

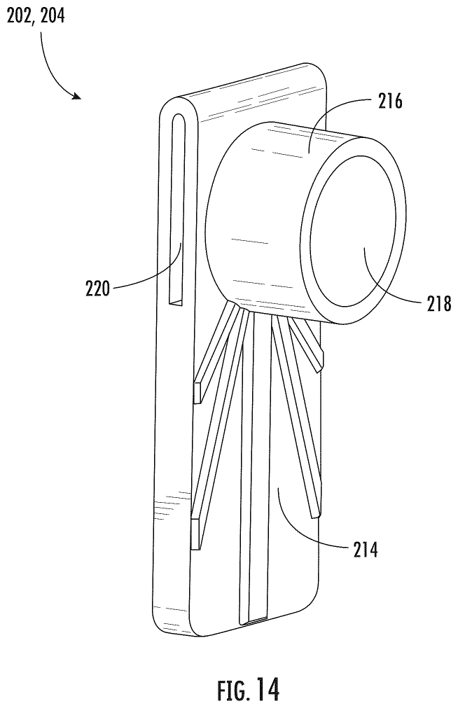

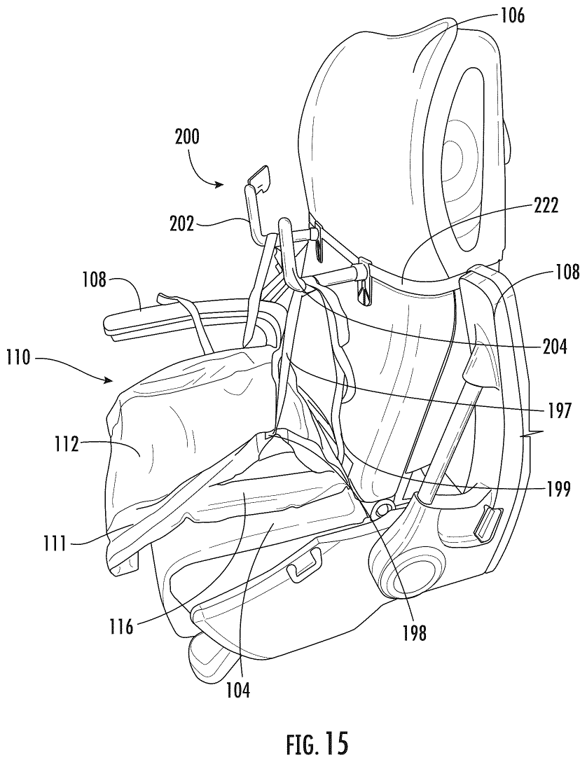

Now referring to FIG. 1 and FIG. 12-15, the positioning system 110 includes a hook system 200. The hook system 200 is positioned around the back 106 to receive the upper extremities of a patient. The hook system 200 is configured to secure a patient in a seated position and mitigate fall risk (e.g., falling forward, falling sideways).

The hook system 200 includes a first hook 202 and a second hook 204. The first hook 202 and the second hook 204 include a first hook arm 206 and a second hook arm 208. The first hook arm 206 and the second hook arm 208 are coupled perpendicularly to form a cavity configured to secure the upper extremities of a patient and prevent movement in a forward direction. The first hook arm 206 and the second hook arm 208 are configured to secure the upper extremities of a patient and prevent movement in a downward direction (e.g., sliding downward in the chair 102). In some embodiments, the first hook 202 and the second hook 204 may include snap locks to adjust the length of the first hook arm 206. In some embodiments, the first hook 202 and the second hook 204 may include snap locks to adjust the angle at which the first hook arm 206 and the second hook arm 208 are coupled.

The hook system 200 includes a first bracket 210 and a second bracket 212. The first bracket 210 and the second bracket 212 includes a base plate 214. The base plate 214 includes a central protrusion 216 with a circular aperture 218 configured to receive the first hook arm 206. In some embodiments, the circular aperture 218 is adapted to match a shape of a cross-section of the first hook 202 and the second hook 204. The base plate 214 further includes a bracket slot 220 configured to receive a hook strap 222.

The hook system 200 includes a hook strap 222. The hook strap 222 extends through the bracket slot 220 of the first bracket 210 and the second bracket 212 such that the first hook 202 and the second hook 204 are movably coupled to the hook strap 222. The hook strap 222 attaches around the back 106 to secure the hook system 200.

In some embodiments, the hook system 200 is configured to receive the strap 197 to stabilize the positioning system 110. In some embodiments, the first hook 202 and second hook 204 are covered in foam to cushion the upper extremities of the patient. In some embodiments, the first hook 202 and the second hook 204 may attach a side of the back 106 via a padded bar comprising a clamp configured to slide the first hook 202 and second hook 204 to a position relative to the patient. In some embodiments, the first bracket 210 and the second bracket 212 include a suction or adhesive configured to secure the hook system 200 to the back 106.

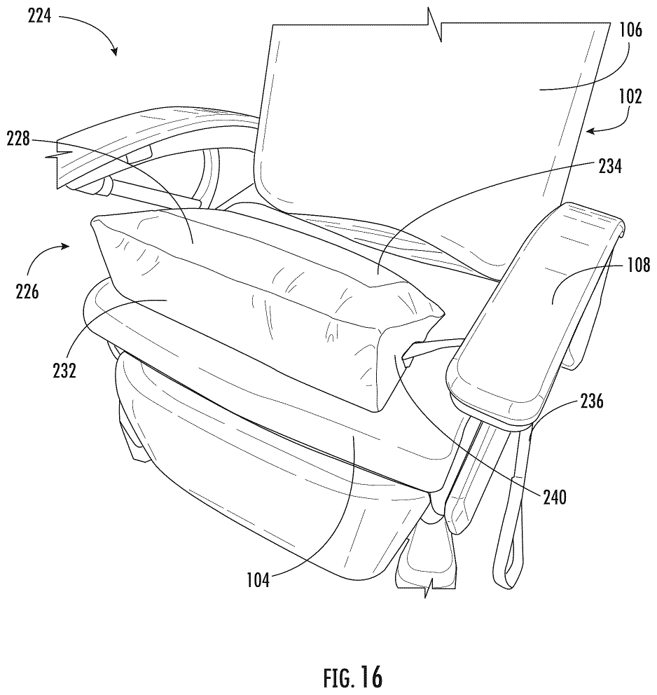

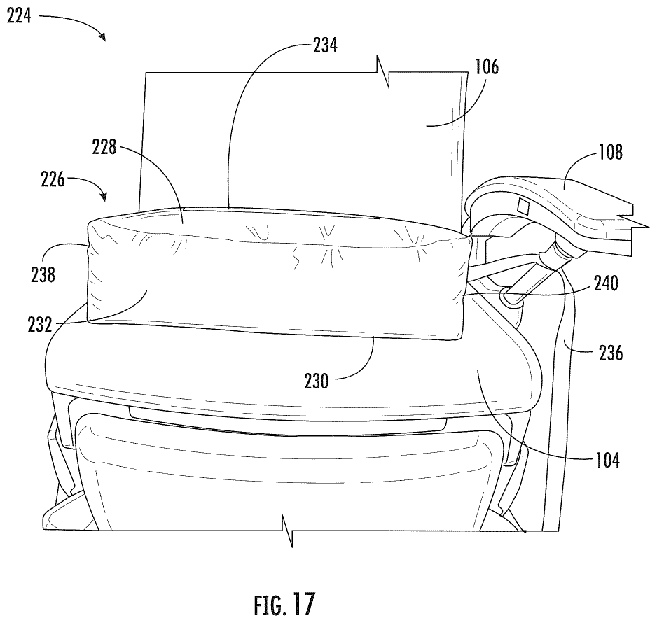

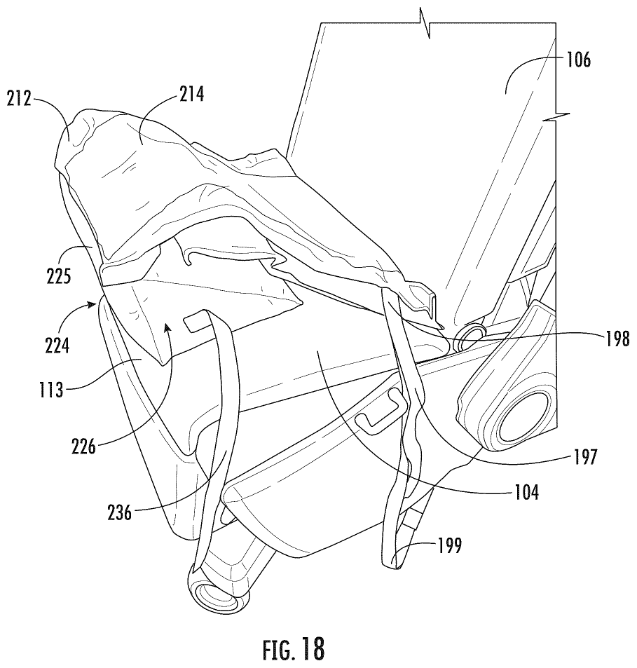

Now referring to FIG. 1 and FIGS. 16-18, the positioning system 110 includes a wedge system 224. The wedge system 224 includes a wedge 226 disposed between the front edge 113 of the seat 104 and bottom edge 225 of the inflatable cushion assembly 116. The wedge 226 includes a first face 228, a second face 230, and a third face 232. In various embodiments, the wedge 226 is configured such that the first face 228, the second face 230, and the third face 232 form a substantially triangular shape. In some embodiments, the wedge 226 is filled with foam (e.g., polyurethane foam, memory foam), gel, stuffing, microbead filling, or similar materials. In some embodiments, the wedge 226 is inflatable.

The first face 228 includes a wedge selective glide region 234 configured to restrict frontward movement and permit rearward movement of a patient placed on the positioning system 110. The wedge selective glide region 234 may include a material with a greater coefficient of friction than that of the base sheet 111. For example, the wedge selective glide region 234 may be constructed of polyester, nylon, foam, rubberized materials, silicone-infused fabrics, cotton, and/or various other materials. As another example, the wedge selective glide region 234 may feature a coating (e.g., a polyurethane or polyvinyl chloride coating) to increase the material's coefficient of friction.

The wedge system 224 includes wedge strap(s) 236 positioned at the first longitudinal edge 238 and the second longitudinal edge 240 of the wedge 226. The wedge strap(s) 236 are elongated pieces of woven material. The wedge strap(s) 236 may also include nylon, polyester, rubber/silicone, canvas, or various other materials. In some embodiments, the wedge strap(s) 236 may include handles (e.g., loops) along its length to provide additional gripping points. Various types of positions or orientations of the handles may be utilized dependent on the size and weight capacity of the positioning system 110. In some embodiments, the wedge strap(s) 236 may include Velcro, zippers, slider closure, a flap, or similar attachment materials to secure the wedge strap(s) 236 together when bound around the chair 102.

In some embodiments, the wedge system 224 is disposed at the front edge 113 of the seat 104, beneath the base sheet 111 and the inflatable cushion assembly 116. In doing so, the wedge system 224 prevents forward movement of the patient by creating a sloped surface to cradle the patient between wedge 226 and the back 106. The wedge system 224 is secured to the arms 108 to stabilize the positioning system 110 via the wedge strap(s) 236. In some embodiments, the wedge system 224 is secured to the bottom of the seat 104 to stabilize the positioning system 110 via the wedge strap(s) 236. In some embodiments, the wedge strap(s) 236 may be secured to the strap 197 of the inflatable cushion assembly 116 and further secured to a component of the chair 102.

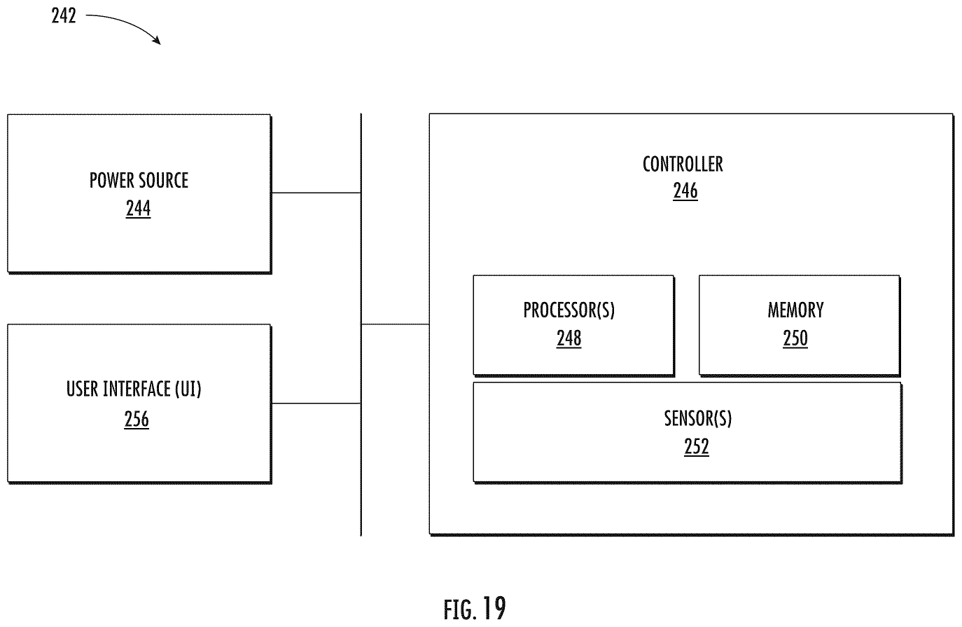

Now referring to FIGS. 1 and 19-21, the seated positioning system 100 may include a patient monitoring system 242. FIG. 19 shows the patient monitoring system 242 in more detail. The patient monitoring system 242 may include real-time patient monitoring capabilities to assess the posture of a patient seated on the positioning system 110 over time. The patient monitoring system 242 may assess body conditions of the patient over time. The body conditions may include temperature, sweat, and time the patient remained in an initial position when seated on the positioning system 110. The patient monitoring system 242 may alert a healthcare professional if a patient has substantially shifted from their initial position on the positioning system 110.

In various embodiments, the patient monitoring system 242 includes a power source 244. In some embodiments, the power source 244 may include a battery. As an example, the patient monitoring system 242 may include a lithium-ion battery, a nickel-metal hydride battery, a nickel-cadmium battery, a lead-acid battery, a solid-state battery, a lithium polymer battery, or a similar medical-grade battery. In other embodiments, the seated positioning system 100 includes the power source 244 (e.g., the power source 244 is not part of the patient monitoring system 242). For example, the power source 244 may include an electrical outlet.

The patient monitoring system 242 includes a controller 246. The controller 246 is configured to control and monitor pressure at various points on the inflatable cushion assembly 116. The controller may receive data extracted from the sensors and create notifications for the healthcare provider. The controller 246 includes one or more processors 248 and memory 250. The one or more processors 248 include any device, component, element, or hardware designed or configured to perform the various steps recited herein.

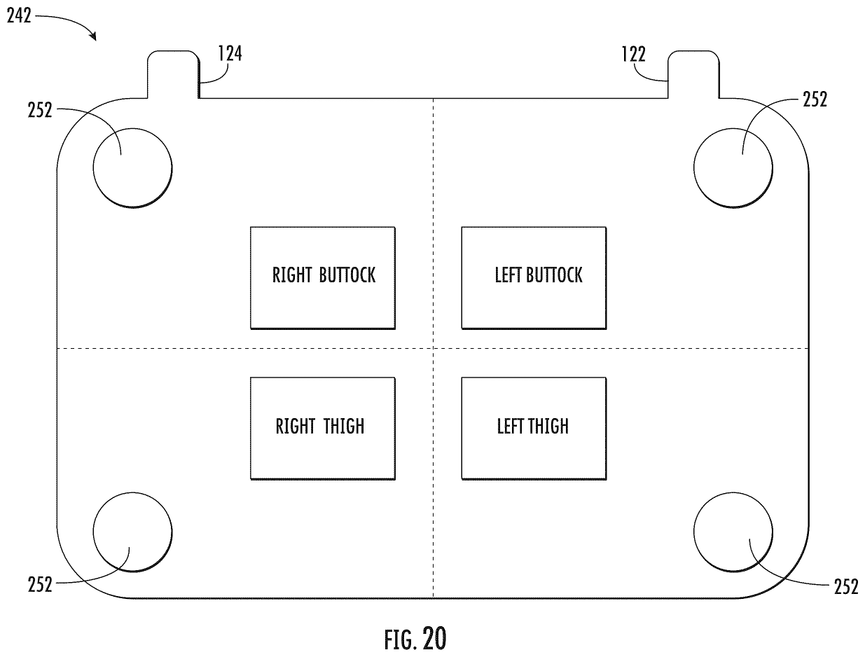

As shown in FIG. 20, the patient monitoring system 242 includes one or more sensors 252. The one or more sensors are placed within exterior pockets arranged on the bottom sheet 119. In some embodiments, the one or more sensors 252 may be embedded in the base sheet 111 of the positioning system 110. In some embodiments, the one or more sensors may be embedded within the top sheet 117.

In some embodiments, the one or more sensors 252 may include a combination of temperature sensors, pressure sensors, and moisture sensors. The temperature sensors may be configured to sense the temperature of a patient while positioned on the seated positioning system 100. The pressure sensors may be configured to sense pressure at various regions of a patient while positioned on the seated positioning system 100. The moisture sensors may be configured to sense an incontinence event and monitor skin conditions of the patient.

As an example, the patient monitoring system 242 includes one or more sensors 252 include pressure sensors (e.g., load cells). In some applications, the one or more sensors 252 may be positioned over the back 106 and seat 104. In other applications, the one or more sensors 252 may be positioned in a grid formation at the outer edges of the positioning system 110. The grid formation may include four quadrants designated for distinct body regions (e.g., left thigh, right thigh, left buttock, and right buttock). The one or more sensors 252 may be spaced apart within the grid formation such that the patient monitoring system 242 detects when a patient is shifting towards a periphery of the seat 104. In some embodiments, one or more sensors 252 may be placed within each quadrant to sensor pressure across each distinct body region to generate a pressure map.

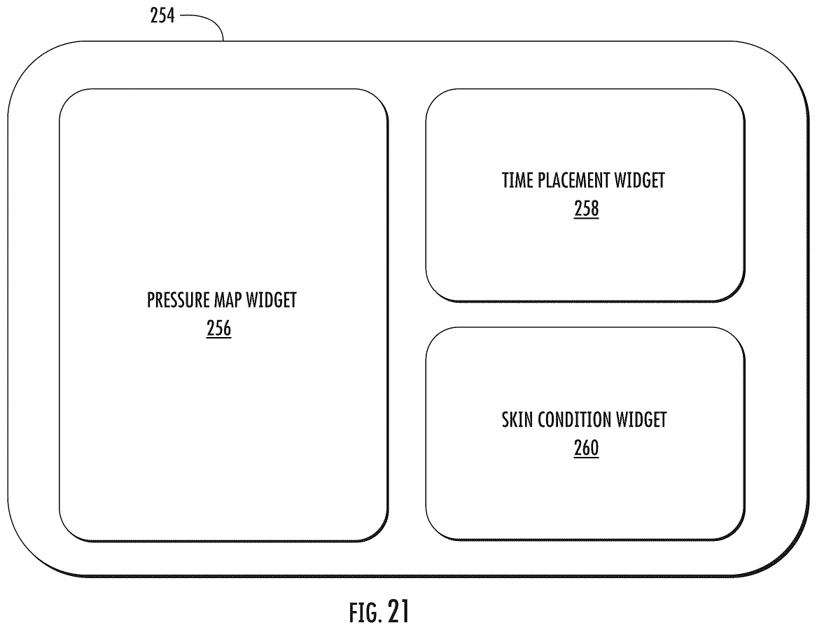

As shown in FIG. 21, the patient monitoring system includes a user interface 254. The user interface 254 may be presented on a smartphone, a tablet, a laptop, or a similar mobile computing device. The user interface 254 may be presented on a pager or wearable communication device. The user interface 254 may be presented at a desktop computer stationed at a nurse or physician's station.

The user interface 254 may display a pressure map widget 256. The pressure map widget 256 may include a two-dimensional model of the sacrum, buttocks, and upper thighs of a patient. The two-dimensional model may extract multiple pressure data points in each quadrant to create a continuous model. In some embodiments, the pressure map widget 256 differentiates areas of varying pressures utilizing a color key. In some embodiments, the pressure map widget 256 enables a user to select areas of pressure to verify their location on the seated positioning system 100 prior to adjusting the positioning of the patient.

The user interface 254 may display a placement time widget 258. The placement time widget 258 may begin tracking when a patient is placed on the seated positioning system 100 and remains sedentary for 10-30 seconds. In some embodiments, the placement time widget 258 may include a countdown timer starting at two hours. In some embodiments, the placement time widget 258 may include a stopwatch configured to count towards the two-hour threshold. The widget may transition colors depending on the urgency of adjusting the positioning a patient (e.g., green when placed on the seated positioning system 100 for under 60 minutes, yellow when placed for 60-90 minutes, orange when placed for 90-120 minutes, red when placed for over 120 minutes).

The user interface may display a skin condition widget 260. The skin condition widget 260 may track various skin conditions such as moisture, incontinence events, and previously logged skin injuries (e.g., pressure injuries, wounds, stitches). The skin condition widget 260 may display an alert if excessive moisture is detected on the seated positioning system 100, indicating an incontinence event. The skin condition widget 260 may display an alert if pressure is detected on an area of a patient's body where a previous skin injury was recorded.

In some embodiments, the user interface 254 may be configured to display notifications generated from data collected by the controller 246. The notifications may include visual signals (e.g., flashing lights, bolded text, warning symbol). The notifications may include auditory signals (e.g., an alarm, beep, buzzer, warning sound). For example, if a patient were to begin slipping (e.g., moving forward on the seated positioning system 100), an alert may be delivered to the healthcare provider regarding the fall risk and instruct the healthcare provider to adjust the positioning of the patient. As another example, in the event a patient has remained in a seated position for more than two hours, an alert may be delivered to the healthcare provider to adjust the positioning the patient to avoid pressure injury. As another example, in the event of incontinence, an alert may be delivered to the healthcare provider to clean the patient and materials of the seated positioning system 100.

### III. Configuration of Example Embodiments

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A positioning system comprising:
a base sheet; and
an inflatable cushion assembly coupled to the base sheet, the inflatable cushion assembly comprising:
a top sheet,
a bottom sheet coupled to the top sheet on a periphery of the bottom sheet and cooperating with the top sheet to form:
an inflatable inner cushion,
an inflatable outer cushion positioned adjacent to the inflatable inner cushion such that the inflatable outer cushion is positioned between the periphery and the inflatable inner cushion, and
a first formed region extending a first distance from a first edge of the bottom sheet to define the inflatable inner cushion and the inflatable outer cushion,
a first one-way valve coupled to the first edge, the first one-way valve being in fluid communication with the inflatable inner cushion and configured to facilitate flow of fluid into the inflatable inner cushion, and
a second one-way valve coupled to the first edge, the second one-way valve being in fluid communication with the inflatable outer cushion and configured to facilitate flow of fluid into the inflatable outer cushion.

2. The positioning system of claim 1, wherein the inflatable cushion assembly further comprises:
a first pressure-relief valve coupled to the first one-way valve at the first edge, the first pressure-relief valve being in fluid communication with the inflatable inner cushion and configured to facilitate flow of fluid out of the inflatable inner cushion; and
a second pressure-relief valve coupled to the second one-way valve at the first edge, the second pressure-relief valve being in fluid communication with the inflatable outer cushion and configured to facilitate flow of fluid out of the inflatable outer cushion.

3. The positioning system of claim 1, wherein the positioning system further comprises a glide system positioned between the base sheet and the top sheet, the glide system comprising:
a first glide sheet having a first coefficient of friction; and
a second glide sheet having a second coefficient of friction, the second glide sheet configured to restrict movement of the base sheet relative to the top sheet in a first direction and facilitate movement of the base sheet relative to the top sheet in a second direction opposite the first direction.

4. The positioning system of claim 1, wherein:
the base sheet has a first coefficient of friction; and
the positioning system further comprises a retention layer coupled to the base sheet, the retention layer having a second coefficient of friction different from the first coefficient of friction, the retention layer configured to prevent movement of a patient placed on the retention layer in a first direction, and facilitate movement in a second direction, the second direction parallel to a side edge of the base sheet.

5. The positioning system of claim 1, wherein the positioning system further comprises a hook system, the hook system comprising:
a first hook;
a first bracket coupled to the first hook, the first bracket comprising a bracket slot;
a second hook;
a second bracket coupled to the second hook, the second bracket comprising the bracket slot; and
a strap extending through the bracket slot such that the first hook and the second hook are movably coupled to the strap.

6. A system comprising:
a chair comprising a seat;
the positioning system of claim 1; and
a strap comprising a first end and a second end, the first end positioned on a longitudinal edge of the inflatable cushion assembly and the second end including a loop;
wherein the inflatable cushion assembly is placed on the seat.

7. The system of claim 6, wherein the positioning system further comprises a wedge system, the wedge system comprising a wedge disposed between a front edge of the inflatable cushion assembly and the seat.

8. The system of claim 7, wherein the wedge system further comprises a selective glide region configured to restrict frontward movement and permit rearward movement of a patient placed on the positioning system, the selective glide region having a greater coefficient of friction than the base sheet.

9. The positioning system of claim 1, wherein the inflatable cushion assembly further comprises:
a second formed region extending a second distance from the first edge of the bottom sheet to define the inflatable inner cushion and the inflatable outer cushion, the second formed region substantially equal in length to the first distance; and
a third formed region extending a third distance to connect the first formed region and the second formed region.

10. The positioning system of claim 1, wherein:
the first one-way valve is positioned at a first tab extending from the first edge, the first tab continuous with the top sheet; and
the second one-way valve is positioned at a second tab extending from the first edge and spaced apart from the first tab, the second tab continuous with the bottom sheet.

11. A positioning system comprising:
a base sheet; and
an inflatable cushion assembly coupled to the base sheet, the inflatable cushion assembly comprising:
a top sheet comprising a first interior surface coated with a first reactant,
a bottom sheet comprising a second interior surface coated with the first reactant, the bottom sheet coupled to the top sheet on a periphery of the bottom sheet to form the inflatable cushion assembly, the first interior surface and the second interior surface positioned towards an interior of the inflatable cushion assembly,
a first formed region extending a first distance from a first edge of the bottom sheet to define an inflatable inner cushion and an inflatable outer cushion,
a first reservoir positioned at a first interior edge of the inflatable outer cushion and configured to enclose a second reactant, and
a first activator positioned over the first reservoir and comprising a protrusion, the protrusion configured to pierce the first reservoir when a first force is applied to the first activator such that the second reactant releases and contacts the first reactant to facilitate a reaction, the reaction producing a first gaseous product configured to fill the inflatable outer cushion.

12. The positioning system of claim 11 wherein the inflatable cushion assembly further comprises:
a first pressure-relief valve positioned at the first edge, the first pressure-relief valve being in fluid communication with the inflatable inner cushion and configured to facilitate flow of fluid out of the inflatable inner cushion; and
a second pressure-relief valve positioned at the first edge, the second pressure-relief valve being in fluid communication with the inflatable outer cushion and configured to facilitate flow of fluid out of the inflatable outer cushion.

13. The positioning system of claim 11, further comprising:
a second reservoir positioned at a second interior edge of the inflatable inner cushion and configured to enclose the second reactant; and
a second activator positioned over the second reservoir and comprising a second protrusion, the second protrusion configured to pierce the second reservoir when a second force is applied to the second activator such that the second reactant releases and contacts the first reactant to facilitate the reaction, the reaction producing a second gaseous product configured to fill the inflatable inner cushion.

14. The positioning system of claim 11, wherein the first reactant is a solid, and the second reactant is a solution.

15. The positioning system of claim 14, wherein the first reactant is sodium bicarbonate, and the second reactant is a citric acid solution.

16. The positioning system of claim 11, wherein the positioning system further comprises a glide system positioned between the base sheet and the top sheet, the glide system comprising:
a first glide sheet having a first coefficient of friction; and
a second glide sheet having a second coefficient of friction, the second glide sheet configured to restrict movement of the base sheet relative to the top sheet in a first direction and facilitate movement of the base sheet relative to the top sheet in a second direction opposite the first direction.

17. The positioning system of claim 11, wherein:
the base sheet has a first coefficient of friction; and
the positioning system further comprises a retention layer coupled to the base sheet, the retention layer having a second coefficient of friction different from the first coefficient of friction, the retention layer configured to prevent movement of a patient placed on the retention layer in a first direction, and facilitate movement in a second direction, the second direction parallel to a side edge of the base sheet.

18. The positioning system of claim 11, wherein the reaction is one of a synthesis reaction, a single replacement reaction, a double replacement reaction, or an acid-base reaction.

19. The positioning system of claim 11, wherein the inflatable cushion assembly further comprises:
a second formed region extending a second distance from the first edge of the bottom sheet to define the inflatable inner cushion and the inflatable outer cushion, the second formed region substantially equal in length to the first distance; and
a third formed region extending a third distance to connect the first formed region and the second formed region.

20. A system comprising:
a chair comprising a seat;
the positioning system of claim 11; and
a strap comprising a first end and a second end, the first end positioned on a longitudinal edge of the inflatable cushion assembly and the second end including a loop;
wherein the inflatable cushion assembly is placed on the seat.
